(19) United States
(12) Patent Application Publication
(10) Pub. No.: US 2003/0148144 A1
(43) Pub. Date: Aug. 7, 2003

(54) COATED TOOL HAVING A LUBRICOUS COATING AND METHOD OF MAKING THE SAME

(76) Inventors: Alfred S. Gates JR., Greensburg, PA (US); Aharon Inspektor, Pittsburgh, PA (US)

Correspondence Address: John J Prizzi, Kennametal Inc, P O Box 231, Latrobe, PA, 15650, US

(21) Appl. No.: 09/504,391

(22) Filed: Feb. 15, 2000

(51) Int. Cl. C04B 35/52

(52) U.S. Cl. 428/698; 501/96.4; 501/87; 501/96.1

(57) ABSTRACT

A coated tool, and a method of making the same, wherein the tool has a substrate with a cutting edge. The tool has a lubricous coating which comprises hexagonal boron nitride in a state of residual compressive stress.

### FIELD OF THE INVENTION

The invention pertains to coated tools such as round tools (which include without limitation drills, end mills, reamers) as well as cutting inserts for the removal of material, e.g., metal, from a workpiece.

### BACKGROUND OF THE INVENTION

A chip-forming machining operation is an exemplary operation which uses a coated cutting insert to which the present invention pertains. During a chip-forming machining operation, the material is typically removed from the workpiece in the form of chips. These chips flow over, and thus contact, the surface of the cutting insert while the cutting edge of the cutting insert is in contact with the workpiece. When a chip flows over the surface of the cutting insert, there is frictional engagement therebetween. The frictional engagement between the chip and the surface of the cutting insert causes the cutting insert to wear.

A reduction in the extent of frictional engagement between the chip and the cutting insert would serve to prolong the useful life of the cutting insert. Heretofore, it has been suggested to apply a coating of sulfides, selenides, and tellurides such as MoS₂, NbS₂, TaS₂, WS₂, MoSe₂, NbSe₂, TaSe₂, WSe₂, TaTe₂, NbTe₂, and WTe₂ to cutting inserts so as to reduce the frictional engagement between the chip and the surface of the cutting insert wherein molybdenum disulfide is the preferred coating material. See PCT Patent Application PCT WO96/30148 for a Cutting Tool to Cselle and Rechberger. Although molybdenum disulfide provides for a lubricous coating layer which reduces friction, it does not possess desirable high temperature stability and high temperature oxidation resistance. High temperature stability and high temperature oxidation resistance are very desirable properties for a cutting insert in view of the high temperatures which exist at the interface between the chip and the surface of the cutting insert and at the interface between the cutting insert and the workpiece.

### SUMMARY OF THE INVENTION

In one form thereof, the invention is a coated tool which includes a substrate with a cutting edge. There is a lubricous coating which comprises hexagonal boron nitride. The hexagonal boron nitride coating is in a state of residual compressive stress.

In another form thereof, the invention is a process for the production of a coated tool comprising the steps of: forming a sintered substrate from a powder mixture; and applying a lubricous coating of hexagonal boron nitride wherein the coating of hexagonal boron nitride is in a state of residual compressive stress.

### BRIEF DESCRIPTION OF THE DRAWINGS

The following is a brief description of the drawings that form a part of this patent application:

FIG. 1 is an isometric view of a specific embodiment of a cutting insert of the invention;

FIG. 2 is a cross-sectional view of a corner of the cutting insert of FIG. 1;

FIG. 3 is a cross-sectional view of a corner of a second specific embodiment of a cutting insert;

FIG. 4 is a cross-sectional view of a corner of a third specific embodiment of a cutting insert;

FIG. 5 is a cross-sectional view of a corner of a fourth specific embodiment of a cutting insert; and

FIG. 6 is a side view of a specific embodiment of a drill.

### DETAILED DESCRIPTION OF THE INVENTION

Referring to the drawings, FIG. 1 depicts specific embodiment of a cutting insert generally designated as 10. Cutting insert 10 has a rake face 12, a flank face 14, and a bottom surface 16. The rake face 12 and the flank faces 14 intersect to form cutting edges 18.

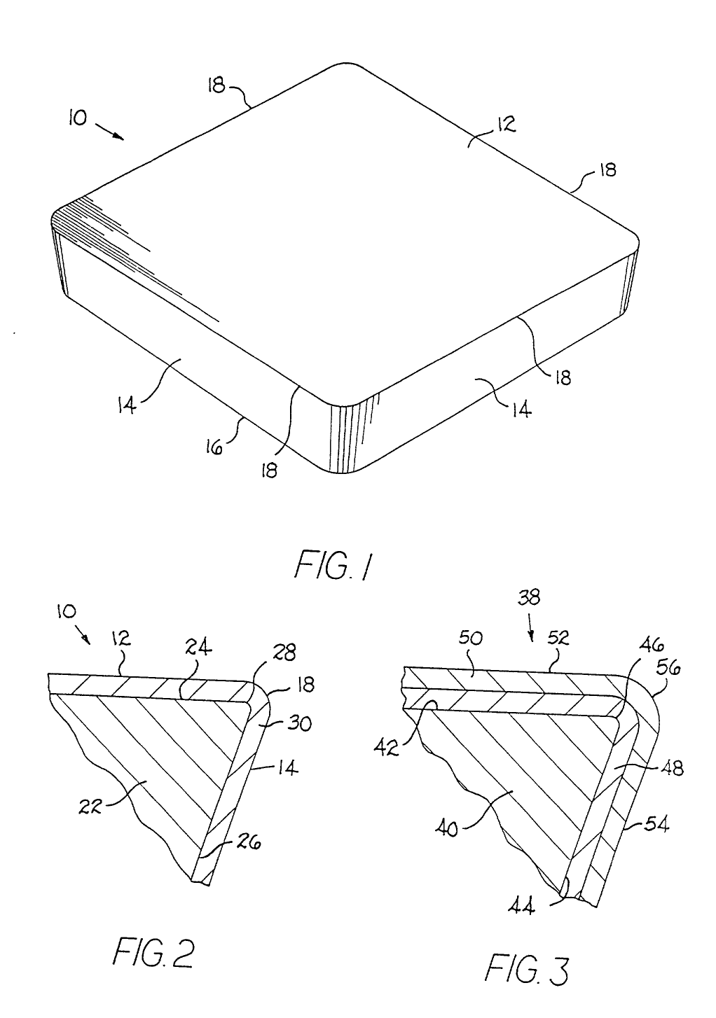

FIG. 2 shows a cross-sectional view of a corner of the cutting insert 10. Cutting insert 10 has a substrate 22 which has a rake surface 24 and a flank surface 26 which intersect to from a substrate cutting edge 28. Substrate materials include tool steels (e.g., high speed steel), cermets, cemented carbides, and ceramics. A typical material for the substrate is a tungsten carbide-cobalt alloy. The cobalt content can vary between about 0.2 weight percent and about 20 weight percent. More preferably, the cobalt content can vary between about 2 weight percent to about 12 weight percent of the substrate. The substrate may contain up to 10 weight percent titanium, up to 10 weight percent tantalum and up to 6 weight percent niobium, as well as minor amounts of vanadium and chromium. One preferred substrate material comprises cobalt in an amount between about 2.3 weight percent and about 2.9 weight percent, up to about 0.4 weight percent tantalum, up to about 0.1 weight percent titanium, and up to about 0.1 niobium, and the balance tungsten carbide. This preferred substrate material has a grain size between 1 micrometer and 6 micrometers and a hardness between 92.8 and 93.6 Rockwell A (R_{A}). Other materials such as, for example, cermets and ceramics, may also be suitable candidates for the substrate material.

A single lubricous coating layer 30 is on the rake surface 24 and the flank surface 26. Lubricous coating layer 30 is in a state of residual compressive stress. The coating layer 30 is hexagonal boron nitride (h-BN). The coating layer 30 may also contain turbostatic boron nitride (t-BN), which is a form of hexagonal boron nitride. The coating layer 30 has a thickness which may range between about 1 micrometer (μm) and about 6 micrometers (μm).

Typical techniques to apply the h-BN include plasma assisted chemical vapor deposition (PACVD) and inductively coupled plasma assisted chemical vapor deposition (ICPACVD) wherein these processes are described in more detail hereinafter. The ICPACVD process is described in the article by M. Kuhr, S. Reinke, and W. Kulisch, Deposition of Cubic Boron Nitride with Inductively Coupled Plasma, Surface and Coatings Technology, 74-75 (1995), pp. 806-812. The PACVD process is described in the article O. Gafri, A. Grill, D. Itzhak, A. Inspektor, and R. Avni, Boron Nitride Coatings on Steel and Graphite Produced in a Low Pressure R. F. Plasma, Thin Solid Films, 72 (1980), pp. 523-527.

Hexagonal boron nitride (including turbostatic boron nitride) is lubricous wherein it provides for excellent lubricity so that chips formed during a chip forming machining operation slide easily over the rake face with a reduced amount of friction. Such a reduction in the amount of friction increases the useful life of the cutting insert. Hexagonal boron nitride (including turbostatic boron nitride) has excellent high temperature stability and oxidation resistance so that it does not degrade upon being subjected to high temperatures typically present at the interface of the cutting insert and the workpiece and at the interface of the chip and the surface of the cutting insert when the chip flows over the surface of the cutting insert.

In regard to the process to produce the cutting insert, the basic steps comprise forming a sintered substrate from a powder mixture through powder metallurgical techniques. In this regard, an exemplary technique comprises ball milling the components of the substrate for a predetermined period of time. The powder mixture is then formed into a green compact via compaction techniques. The green compact is then consolidated (e.g., sintering) to form the sintered substrate.

The process next comprises applying to the surface of the sintered substrate a lubricous coating of hexagonal boron nitride wherein the coating of hexagonal boron nitride is in a state of residual compressive stress. More specifically, the coating process is a chemical vapor deposition process including PACVD or ICPACVD wherein such processes are described in the articles already identified herein.

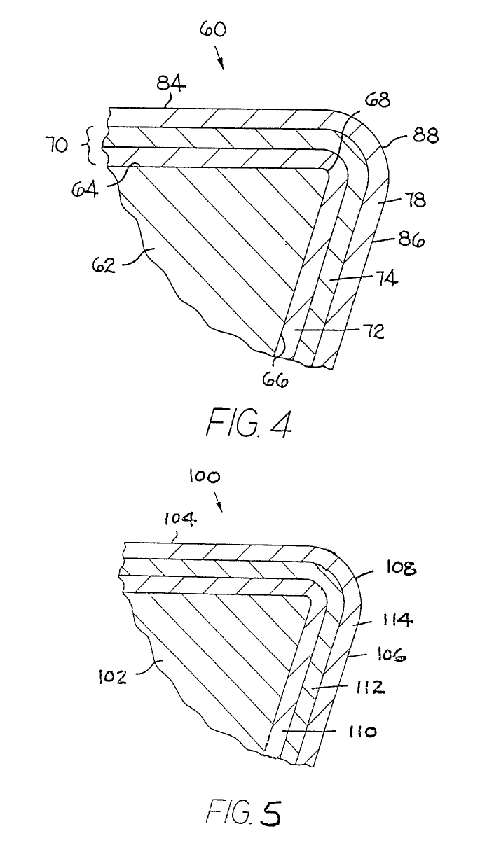

FIG. 3 shows a cross-sectional view of a corner of another specific embodiment of a cutting insert, generally designated as 38, which has a substrate 40 Substrate 40 has a rake surface 42 and a flank surface 44 which intersect to from a substrate cutting edge 46.

An intermediate coating scheme in the specific embodiment of FIG. 3, which comprises a single intermediate coating layer 48, is on the surface of the substrate. The intermediate coating layer 48 may be applied by chemical vapor deposition (CVD) or by physical vapor deposition (PVD) techniques. Intermediate coating layer 48 may comprise one of the transition metal Groups IV, V and VI nitrides, carbonitrides, carbides, oxynitrides, oxycarbides, oxides and borides, alumina, cubic boron nitride, diamond, titanium aluminum nitride, and titanium aluminum carbonitride. The thickness of the intermediate coating layer 48 may range between about 1 micrometer (μm) and about 6 micrometers (μm).

An exterior lubricous coating 50 is on the surface of the intermediate coating layer 48. The lubricous coating 50 is hexagonal boron nitride (h-BN). The lubricous coating 50 may also contain turbostatic boron nitride (t-BN), which is a highly stressed form of hexagonal boron nitride. The exterior lubricous coating 50 has a thickness which may range between about 1 micrometer (μm) and about 6 micrometers (μm). Typical techniques to apply the hexagonal boron nitride coating include PACVD and ICPACVD as described in the articles identified hereinabove. The hexagonal boron nitride (including turbostatic boron nitride) exterior lubricous coating 50 provides for the same excellent lubricity as does the lubricous coating layer 30 for cutting insert 10 described above. It is expected that the hardness of the lubricous coating 50 is less than the hardness of the intermediate coating layer 48.

The coated cutting insert 38 has a rake face 52 and a flank face 54. The rake face 52 intersects with the flank face 54 to form a cutting edge 56 for the coated cutting insert 38.

In regard to the process of producing the cutting insert, the basic process comprises a first step of forming a sintered substrate from a powder mixture. Like for cutting insert 10, this step is typically performed via typical powder metallurgical techniques.

The next step comprises applying an intermediate coating scheme to the surface of the sintered substrate. The specific embodiment of FIG. 3 depicts an intermediate coating scheme with a single layer which is the outermost layer. The intermediate coating scheme may be applied by chemical vapor deposition (CVD) techniques or physical vapor deposition (PVD) techniques.

The final step comprises applying the lubricous exterior coating layer of hexagonal boron nitride to the intermediate coating layer. This step is like the coating step for applying the lubricous layer to the cutting insert 10 and may use the PACVD technique or the ICPACVD technique to apply the hexagonal boron nitride coating.

FIG. 4 shows a cross-sectional view of a corner of a third specific embodiment of a cutting insert generally designated as 60. Cutting insert 60 has a substrate 62 which presents a rake surface 64 and a flank surface 66. The rake surface 64 and the flank surface 66 intersect to from a substrate cutting edge 68.

The substrate 62 has thereon an intermediate coating scheme 70. Intermediate coating scheme 70 has an innermost (or interior) intermediate coating layer 72 next to the surface of the substrate 62. Intermediate coating scheme 70 has an outermost (or exterior) intermediate coating layer 74 on the surface of the innermost coating layer 72. One example of a two, i.e., multi-layer, intermediate coating scheme is an interior intermediate layer of titanium carbide on the surface of the substrate with an exterior intermediate layer of alumina on the titanium carbide layer. The intermediate coating scheme has a thickness that ranges between about 1 micrometer and about 15 micrometers.

Applicants also contemplate that the intermediate coating scheme may comprise more than two layers. One example of a multi-layer intermediate coating scheme with more than two layers is an interior intermediate layer of titanium carbide on the surface of the substrate, a mediate layer of titanium carbonitride on the titanium carbide layer, and an exterior intermediate layer of titanium nitride on the surface of the layer of titanium carbonitride.

Referring to FIG. 4, the cutting insert 60 has an exterior lubricous coating layer 78 on the surface of the outermost intermediate coating layer 74. The exterior lubricous coating layer 78 is hexagonal boron nitride (h-BN). The exterior lubricous coating layer 78 may also contain turbostatic boron nitride (t-BN), which is a highly stressed form of hexagonal boron nitride. The exterior coating layer 78 has a thickness which may range between about 1 micrometer (μm) and about 6 micrometers (μm). Typical techniques to apply the hexagonal boron nitride include PACVD and ICPACVD such as those described in the articles identified hereinabove. The hexagonal boron nitride (including turbostatic boron nitride) exterior coating layer 78 provides for the same excellent lubricity as does the coating layer 30 for cutting insert 10 described above. It is expected that the hardness of the lubricous layer 78 is not as great as the hardness of the intermediate coating scheme 70. Cutting insert 60 presents a rake face 84 and a flank face 86. The rake face 84 and the flank face 86 intersect to form a cutting edge 88.

In regard to the process of producing the cutting insert, the basic steps are like those for the production of cutting insert 38. The difference is that the intermediate coating scheme comprises two distinct coating layers rather than one intermediate coating layer. These coating layers may be applied via CVD or PVD techniques so that both layers may be CVD layers, both layers may be PVD layers, or one layer may be a CVD layer and the other layer may be a PVD layer.

Applicants also contemplate coating schemes in which there is an outer coating scheme comprising one or more layers on top of the lubricous hexagonal boron nitride layer. In this regard, FIG. 5 illustrates a cross-sectional view of a corner of another specific embodiment of a cutting insert generally designated as 100. Cutting insert 100 has a substrate 102. The cutting insert 100 also has a rake surface 104 and a flank surface 106 which intersect to form a cutting edge 108 of the cutting insert.

In this specific embodiment of FIG. 5 there is an intermediate coating scheme which comprises one intermediate coating layer 110. Coating layer 110 is applied directly to the surface of the substrate by either CVD techniques or PVD techniques. Coating layer 110 may comprise one of the transition metal Groups IV, V and VI nitrides, carbonitrides, carbides, oxynitrides, oxycarbides, oxides and borides, alumina, cubic boron nitride, diamond, titanium aluminum nitride, and titanium aluminum carbonitride. The thickness of the intermediate coating layer 110 may range between about 1 micrometer (μm) and about 15 micrometers (μm).

It should be appreciated that the intermediate coating scheme could comprise multiple coating layers. In the case of multiple layers one or more of the layers could be applied via CVD techniques or one or more of the layers could be applied by PVD techniques.

There is a lubricous coating layer 112 applied by either a PACVD technique or a ICPACVD technique directly to the surface of the intermediate coating layer 110. The lubricous coating 112 comprises hexagonal boron nitride which may include turbostatic boron nitride.

In the specific embodiment of FIG. 5 there is shown an outer coating scheme of a single layer 114 applied to the surface of the lubricous coating layer 112. Coating layer 114 is applied directly to the surface of the lubricous layer 112 by either CVD techniques or PVD techniques. It should be appreciated that the outer coating scheme could comprise multiple coating layers. In the case of multiple layers one or more of the layers could be applied via CVD techniques or one or more of the layers could be applied by PVD techniques. Coating layer 114, as well as each layer of a multiple layer outer coating scheme, may comprise one of the transition metal Groups IV, V and VI nitrides, carbonitrides, carbides, oxynitrides, oxycarbides, oxides and borides, alumina, cubic boron nitride, diamond, titanium aluminum nitride, and titanium aluminum carbonitride. The thickness of the outer coating layer 114 may range between about 1 micrometer (μm) and about 6 micrometers (μm).

In regard to the process of producing the cutting insert, the basic process comprises a first step of forming a sintered substrate from a powder mixture. Like for cutting insert 10, this step is typically performed via typical powder metallurgical techniques.

The next step comprises applying an intermediate coating scheme to the surface of the sintered substrate. The specific embodiment of FIG. 5 depicts an intermediate coating scheme with a single layer which is the outermost layer. The intermediate coating scheme may be applied by chemical vapor deposition (CVD) techniques or physical vapor deposition (PVD) techniques.

The next step comprises applying the lubricous exterior coating layer of hexagonal boron nitride to the intermediate coating layer. This step is like the coating step for applying the lubricous layer to the cutting insert 10 and may use the PACVD technique or the ICPACVD technique to apply the hexagonal boron nitride coating.

The final step comprises applying the outer coating scheme to the surface of the lubricous layer. The specific embodiment of FIG. 5 depicts an outer coating scheme with a single layer which is the outermost layer. The outer coating scheme may be applied by chemical vapor deposition (CVD) techniques or physical vapor deposition (PVD) techniques.

The following examples are representative of coating schemes wherein there is an outer coating scheme of one or more layers on the lubricous coating layer. For example, one coating scheme may comprise (a) an intermediate layer of titanium nitride on the surface of the substrate; (b) a layer of hexagonal boron nitride on the surface of the intermediate layer of titanium nitride; and (c) a layer of titanium nitride on the surface of the layer of hexagonal boron nitride. Another example of such a coating scheme comprises (a) an intermediate layer of titanium carbide on the surface of the substrate; (b) a layer of alumina on the surface of the titanium carbide intermediate layer; (c) a layer of hexagonal boron nitride on the surface of the alumina later; and (d) a layer of titanium nitride on the surface of the hexagonal boron nitride layer. Still another example of a coating scheme with one or more layers on the hexagonal boron nitride layer comprises (a) an intermediate layer of titanium carbide on the surface of the substrate; (b) a layer of alumina on the surface of the titanium carbide intermediate layer; (c) a layer of hexagonal boron nitride on the surface of the alumina later; (d) a layer of alumina on the surface of the hexagonal boron nitride layer; and (e) a layer of titanium nitride on the surface of the outermost alumina layer.

The following specific examples demonstrate that the present invention reduces the frictional engagement between the surface of the cutting insert and the chip. In this regard, a reduction in the surface roughness of the cutting insert shows that the extent of frictional engagement would also decrease.

Six cutting inserts were made according to powder metallurgical techniques from a tungsten carbide-cobalt alloy having the following composition: cobalt in an amount between about 2.3 weight percent and about 2.9 weight percent, up to about 0.4 weight percent tantalum, up to about 0.1 weight percent titanium, and up to about 0.1 niobium, and the balance tungsten carbide. Three cutting inserts were coated with a coating of hexagonal boron nitride, including some turbostatic boron nitride, according to the plasma assisted chemical vapor deposition (PACVD) technique.

Three cutting inserts were left uncoated.

The surface roughness of the six cutting inserts was measured using a Sheffield profilometer with the following results as set forth in Table I.

TABLE I
Tests Results for Surface Roughness

| | Surface Roughness | Surface Roughness Rₐ |
|---|---|---|
| Sample | Rₜₘ (microinches) | (microinches) |
| Coated No. 1 | 30 | 3 |
| Coated No. 2 | 25 | 3 |
| Coated No. 3 | 27 | 3 |
| Uncoated No. 1 | 40 | 5 |
| Uncoated No. 2 | 45 | 5 |
| Uncoated No. 3 | 45 | 5 |

The average surface roughness for the uncoated cutting inserts was 43.3, Rₜₘ, microinches and 5, Rₐ, microinches. This is greater than the average surface roughness for the coated cutting inserts (27.3, Rₜₘ, microinches and 3, Rₐ, microinches). It is thus very apparent that the cutting inserts with the coating of hexagonal boron nitride (including turbostatic boron nitride) exhibit a lower surface roughness. A cutting insert with a low surface roughness will result in a decrease in the extent of the frictional engagement between the surface of the cutting insert and a chip flowing thereover.

Referring to the cutting insert (the substrate was a tungsten carbide-based cobalt alloy) with the hexagonal boron nitride coating applied via ICPACVD, a ball wear scar technique was used to measure the thickness of the hexagonal boron nitride coating for the coated cutting insert wherein the hexagonal boron nitride coating was deposited via the ICPACVD technique. During the measurement, it took 4 minutes to wear the scar through the 5 micrometer thick hexagonal boron nitride coating using a 0.25 micrometer diamond paste. This was in contrast to a time of 2 minutes that was necessary to wear a scar through a 6 micrometer thick coating of titanium carbide using the same 0.25 micrometer diamond paste. The microhardness of the titanium carbide was more than double the microhardness of the hexagonal boron nitride. It took twice as long to wear the scar through the hexagonal boron nitride coating as it took to wear the scar through the titanium carbide coating even though these coatings were of similar thickness. This result, i.e., the difference in time needed to wear through the scar, was due to the lubricous nature of the hexagonal boron nitride coating in contrast to the titanium carbide coating which was not as lubricous in nature.

Transition electron microscopic (TEM) examination of the hexagonal boron nitride coating as applied via the ICPACVD technique revealed that the hexagonal boron nitride coating was principally amorphous with cluster of turbostatic boron nitride (t-BN). Turbostatic boron nitride is a highly stressed form of hexagonal boron nitride.

The sample of the hexagonal boron nitride coating deposited via the ICPACVD technique on the cemented carbide cutting insert prepared for TEM examination showed that the hexagonal boron nitride coating had residual compressive stresses. When the sample was thinned for TEM examination it was found that the coated substrate around the thinned section cracked and bent in towards the substrate thereby showing that the coating had high compressive stresses since an uncoated cemented carbide substrate without a coating does not show this bending and cracking. The presence of residual compressive stress on the exterior coating layer provides certain advantages as set forth in the following United States patents (all of which are owned by the assignee of the present patent application, Kennametal Inc.): U.S. Pat. No. 5,232,318 to Santhanam et al. for COATED CUTTING TOOLS; U.S. Pat. No. 5,266,388 to Santhanam et al. for a BINDER ENRICHED COATED CUTTING TOOL; and U.S. Pat. No. 5,395,680 to Santhanam et al. for COATED CUTTING TOOLS.

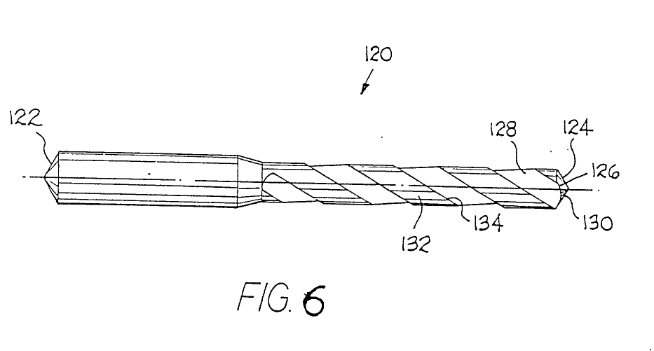

Referring to FIG. 6, there is illustrated a drill generally designated as 120. Drill 120 has an axially rearward end 122 and an axially forward end 124. There is a forward surface 126 which intersects with a surface 128 defined by the flute to form a forward cutting edge 130. The surface 128 defined by the flute also intersects the cylindrical side surface 132 to form a side cutting edge 134. It can thus be appreciated that the drill presents one pair of surfaces (surface 126 and surface 128) which define one edge (edge 130), and another pair of surfaces (surface 128 and surface 132) which define another edge (edge 134). Although not shown, drill 120 has a multi-layer coating scheme of the invention deposited thereon.

The patents and other documents identified herein are hereby incorporated by reference herein.

Other embodiments of the invention will be apparent to those skilled in the art from a consideration of the specification or practice of the invention disclosed herein. It is intended that the specification and examples be considered as illustrative only, with the true scope and spirit of the invention being indicated by the following claims.

What is claimed is:

1. A coated tool comprising:
a substrate having a cutting edge; and
a lubricous coating of hexagonal boron nitride on the substrate, and the coating being in a state of residual compressive stress.

2. The coated tool of claim 1 wherein the lubricous coating being applied directly to the surface of the substrate.

3. The coated tool of claim 1 wherein the lubricous coating being applied by a method selected from the group consisting of inductively coupled plasma assisted chemical vapor deposition and plasma assisted chemical vapor deposition.

4. The coated tool of claim 1 wherein the lubricous coating being of a thickness between about 1 micrometer and about 6 micrometers.

5. The coated tool of claim 1 further comprising an intermediate coating scheme comprising one or more layers; and wherein the intermediate coating scheme being applied directly to the surface of the substrate.

6. The coated tool of claim 5 wherein each layer of the intermediate coating scheme being selected from the group consisting of the transition metal Groups IV, V and VI nitrides, carbonitrides, carbides, oxynitrides, oxycarbides, oxides and borides, alumina, cubic boron nitride, diamond, titanium aluminum nitride, and titanium aluminum carbonitride.

7. The coated tool of claim 5 wherein the intermediate coating scheme being of a thickness between about 1 micrometer and about 6 micrometers.

8. The coated tool of claim 5 wherein the intermediate coating scheme comprises an interior intermediate layer being applied directly to the surface of the substrate, and the interior intermediate layer comprising titanium carbide; and the intermediate coating scheme further comprising an exterior intermediate layer selected from the group consisting of titanium nitride and alumina.

9. The coated tool of claim 8 wherein the intermediate coating scheme further comprising a mediate layer between the interior intermediate layer and the exterior intermediate layer, and the mediate layer comprising titanium carbonitride.

10. The coated tool of claim 5 wherein at least one of the layers of the intermediate coating scheme is applied by physical vapor deposition.

11. The coated tool of claim 5 wherein at least one of the layers of the intermediate coating scheme is applied by chemical vapor deposition.

12. The coated tool of claim 5 wherein the intermediate coating scheme comprises at least two coating layers, and wherein one of the layers being applied by physical vapor deposition and another of the layers being applied by chemical vapor deposition.

13. The coated tool of claim 5 wherein the lubricous coating being applied to the intermediate coating scheme.

14. The coated tool of claim 5 wherein the lubricous coating has a hardness that is less than the hardness of the intermediate coating scheme.

15. The coated tool of claim 1 wherein an outer coating scheme comprising one or more layers being applied to the surface of the lubricous coating.

16. The coated tool of claim 15 wherein each one of the layers of the outer coating scheme being selected from the group consisting of the transition metal Groups IV, V and VI nitrides, carbonitrides, carbides, oxynitrides, oxycarbides, oxides and borides, alumina, cubic boron nitride, diamond, titanium aluminum nitride, and titanium aluminum carbonitride.

17. The coated tool of claim 15 wherein at least one of the layers of the outer coating scheme is applied by physical vapor deposition.

18. The coated tool of claim 15 wherein at least one of the layers of the outer coating scheme is applied by chemical vapor deposition.

19. The coated tool of claim 15 wherein the outer coating scheme comprises at least two coating layers, and wherein one of the layers being applied by physical vapor deposition and another of the layers being applied by chemical vapor deposition.

20. The coated tool of claim 1 wherein the lubricous coating further comprises turbostatic boron nitride.

21. The coated tool of claim 1 wherein the substrate being selected from the group consisting of cemented carbides, cermets and ceramics.

22. The coated tool of claim 1 wherein the substrate comprises tungsten carbide and cobalt, and the cobalt being present in an amount between about 0.2 weight percent to about 20 weight percent of the substrate.

23. The coated tool of claim 1 wherein the substrate comprises up to 10 weight percent tantalum, up to 10 weight percent titanium, up to 6 weight percent niobium, and between about 2 weight percent and about 12 weight percent cobalt.

24. The coated tool of claim 1 wherein the surface of the coated tool has a surface roughness, Rₐ, that ranges between about 25 microinches and about 30 microinches.

25. The coated tool of claim 1 wherein the substrate presenting a rake surface and a flank surface, and the cutting edge being at the intersection of the rake surface and the flank surface.

26. A process for the production of a coated tool comprising the steps of:
forming a sintered substrate from a powder mixture; and
applying a lubricous coating of hexagonal boron nitride wherein the coating of hexagonal boron nitride is in a state of residual compressive stress.

27. The process of claim 26 wherein the lubricous coating being applied directly to the surface of the sintered substrate.

28. The process of claim 26 wherein the lubricous coating being applied by one method selected from the group consisting of plasma assisted chemical vapor deposition and inductively coupled plasma assisted chemical vapor deposition.

29. The process of claim 26 further including the step of applying an intermediate coating scheme of one or more layers directly to the surface of the sintered substrate wherein each one of the layers of the intermediate coating scheme being selected from the group consisting of the transition metal Groups IV, V and VI nitrides, carbonitrides, carbides, oxynitrides, oxycarbides, oxides and borides, alumina, cubic boron nitride, diamond, titanium aluminum nitride, and titanium aluminum carbonitride; and the lubricous coating being applied to the intermediate coating scheme.

30. The process of claim 29 wherein at least one of the layers of the intermediate coating scheme being applied by physical vapor deposition.

31. The process of claim 29 wherein at least one of the layer of the intermediate coating scheme being applied by chemical vapor deposition.

32. The process of claim 29 wherein the intermediate coating scheme comprises at least two coating layers, and wherein one of the layers being applied by physical vapor deposition and another of the layers being applied by chemical vapor deposition.

33. The process of claim 26 wherein the lubricous coating further including turbostatic boron nitride.

34. The process of claim 26 wherein the powder mixture comprises tungsten carbide and cobalt

35. The process of claim 34 wherein the powder mixture further comprises up to 10 weight percent tantalum, up to 10 weight percent titanium, up to 6 weight percent niobium, and between about 0.2 weight percent and about 20 weight percent cobalt.

36. The process of claim 29 further including the step of applying an outer coating scheme of one or more layers to the lubricous coating.

37. The process of claim 36 wherein each one of the layers of the outer coating scheme being selected from the group consisting of the transition metal Groups IV, V and VI nitrides, carbonitrides, carbides, oxynitrides, oxycarbides, oxides and borides, alumina, cubic boron nitride, diamond, titanium aluminum nitride, and titanium aluminum carbonitride.

38. The process of claim 36 wherein at least one of the layers of the outer coating scheme being applied by physical vapor deposition.

39. The process of claim 36 wherein at least one of the layer of the outer coating scheme being applied by chemical vapor deposition.

40. The process of claim 36 wherein the outer coating scheme comprises at least two coating layers, and wherein one of the layers being applied by physical vapor deposition and another of the layers being applied by chemical vapor deposition.

41. The process of claim 26 wherein the lubricous coating being applied by a method selected from the group consisting of plasma assisted chemical vapor deposition and inductively coupled plasma assisted chemical vapor deposition.
